(19) United States
(12) Patent Application Publication
(10) Pub. No.: US 2014/0158419 A1
(43) Pub. Date: Jun. 12, 2014

(54) CABLE RETAINER

(71) Applicant: Dieter Ramsauer, Schwelm (DE)

(72) Inventor: Dieter Ramsauer, Schwelm (DE)

(21) Appl. No.: 14/005,147

(22) PCT Filed: Mar. 1, 2012
(86) PCT No.: PCT/EP2012/000887

§ 371 Date: Oct. 21, 2013

(30) Foreign Application Priority Data
Mar. 16, 2011 (DE) 20 2011 004 055.0

(51) Int. Cl. H02G 3/32

(52) U.S. Cl. CPC H02G 3/32
USPC 174/480

(57) ABSTRACT

A cable retainer for fastening cables or cable bundles in thin-walled cabinets, such as sheet metal cabinets, provided with a perforation pattern, having a base region which allows fastening in an opening in the thin wall and from which holding strips emerge, which holding strips can be connected to one another at the free ends thereof so as to encircle a cable bundle cross section, characterized in that the connection is carried out by means of a pin which emerges from the middle of the holding strip and fits into a suitable bore hole located in direction of the cable in the other holding strip and in that cable protectors can be snapped onto the holding strips.

The present application claims priority from PCT Patent Application No. PCT/EP2012/000887 filed on Mar. 1, 2012, which claims priority from German Patent Application No. DE 20 2011 004 055.0 filed on Mar. 16, 2011, the disclosures of which are incorporated herein by reference in their entirety.

### FIELD OF THE INVENTION

The invention is directed to a cable retainer for horizontal or vertical fastening of cables or cable bundles in thin-walled cabinets, such as sheet metal cabinets, provided with a perforation pattern, having a base region which allows fastening in an opening in the thin wall and from which holding strips emerge, which holding strips can be connected to one another at the free ends thereof so as to encircle a cable bundle cross section.

It is noted that citation or identification of any document in this application is not an admission that such document is available as prior art to the present invention.

A cable retainer of the general type mentioned above is already known from Company Brochure 09.7 by DIRAK GmbH, Königsfelder Str. 1, 58256 Ennepetal.

This cable holder has the drawback of the hook-shaped connection which can accidentally disengage when the hook connection is put into shear Further, it is disadvantageous that the cross sections of the cables are sharply bent at the edge of the cable strip and can suffer damage.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

It is the object of the invention to overcome the disadvantages of the prior art and to provide alternatives to the prior art.

The above-stated object is met in that the one holding strip forms or has at its free end a laterally directed pin, and in that the other holding strip forms a bore hole for receiving the pin, the pin being insertable therein.

According to a further development of the invention, spring tension is generated by a leaf-spring-like structure of the holding strip between pin and bore hole.

According to yet another further development, pin and bore hole have knurled or roughened surfaces to achieve a locking of the pin in the bore hole.

To protect the cable or cable bundle, it can be advantageous according to yet another further development when the holding strips have a cable protector which can be snapped on.

In particular, the cable protector can have a semicircular profile having a radius that is appreciably greater than the width of the holding strips, wherein the semicircular profile and the extends between the profile edges and the cable bundle in the assembled position.

According to yet another further development of the invention, holding tabs which enclose the holding strips under pressure emerge from the inner surface of the semicircular profile.

The holding strips can also form a parallelogram after connection of the free ends.

The connection can preferably be carried out by means of a pin which emerges from the middle of the one holding strip and can be received in a suitable bore hole extending in profile direction in the other holding strip.

The semicircular profile can be bent outward in the middle of the longitudinal extension.

The bending angle can be approximately 30 degrees.

The base region should comprise an approximately square base plate with side length 3S with a square opening with side length 1S, where S is a hole pitch of the perforation of the cabinet.

The base region is provided on one side in running direction of the cable with a spacer or reinforcing insert which projects into a pitch opening by distance S.

The openings can be penetrated by a square clip-like holding element.

According to a further development of the invention, the cable has a semicircular profile with a radius of the width of the holding strips so that no betiding forces occur between the profiles and the cable bundles.

According to another further development of the invention, holding tabs emerge from the inner surface of the semicircular profile so as to enclose the holding strips under pressure.

The arrangement is carried out such that the holding tabs form a parallelogram when the free ends are joined.

### BRIEF DESCRIPTION OF THE DRAWINGS

FIG. 1A shows a perspective view of a first embodiment form of a cable retainer configured according to the invention;

FIG. 1B shows a front view of a first embodiment form of a cable retainer configured according to the invention;

FIG. 1C shows a side view of a first embodiment form of a cable retainer configured according to the invention; and

FIG. 1D shows a bottom elevational view of a first embodiment form of a cable retainer configured according to the invention;

FIGS. 2A to 2D show similar views of a second embodiment form;

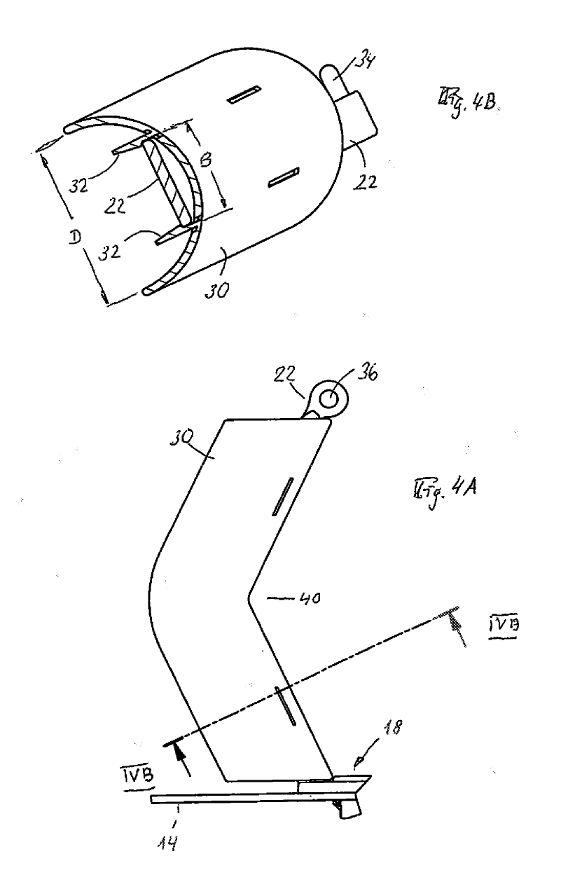

FIGS. 3A, 3B, and 3C show perspective views showing the process of assembling the cable retainer;

FIGS. 4A to 4H show perspective views showing the installation of the cable retainer with a bending protection arrangement.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

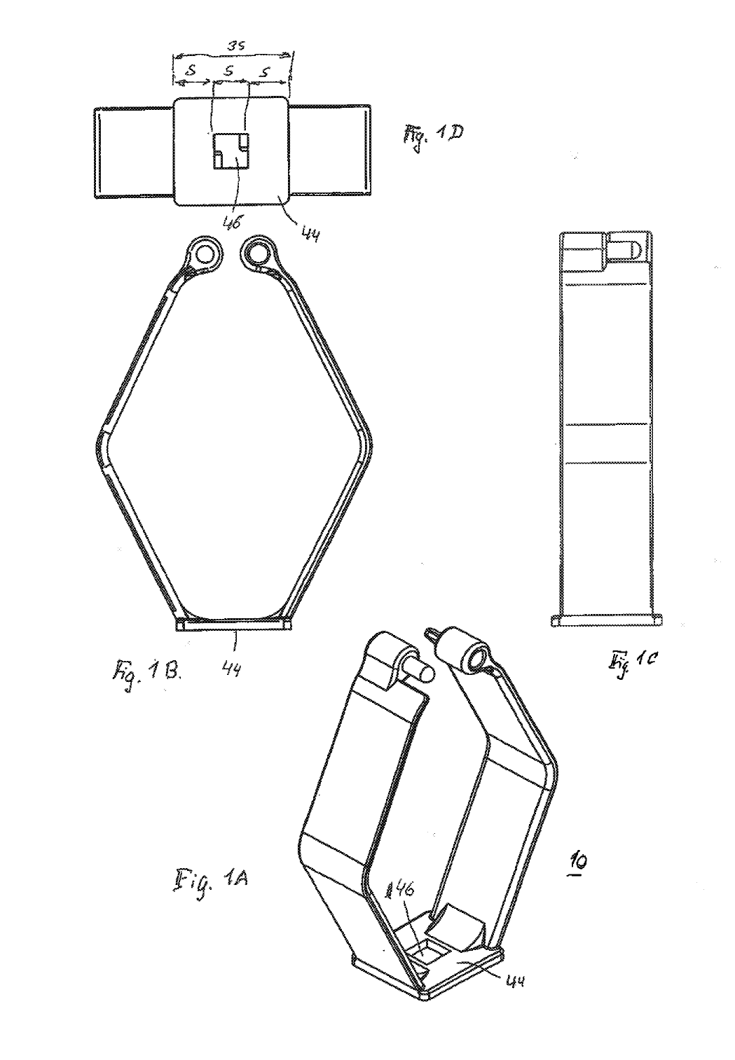

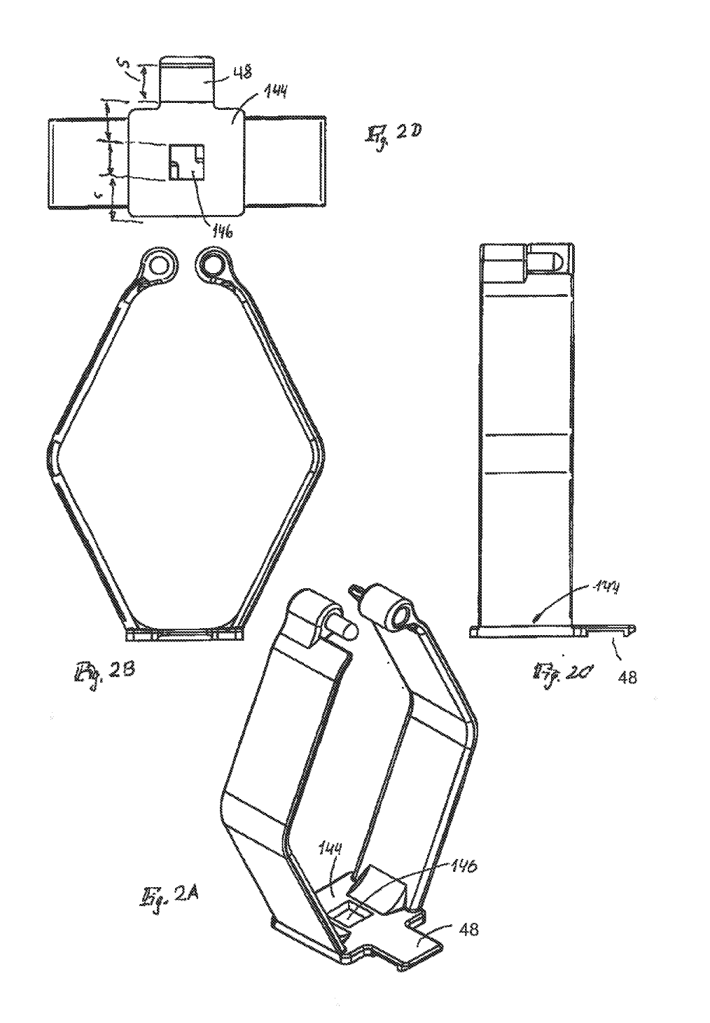

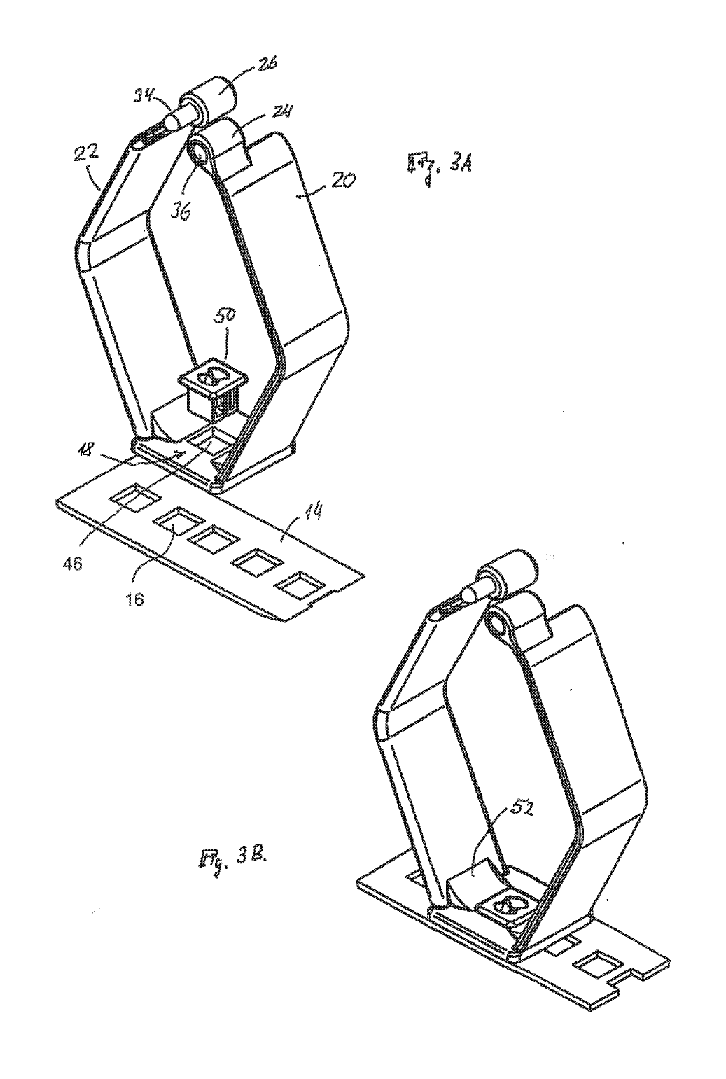

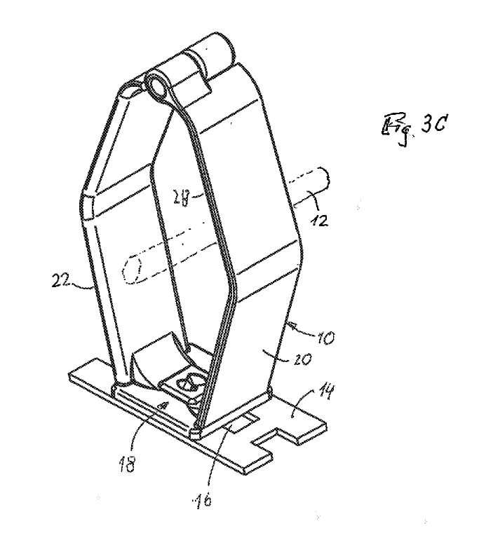

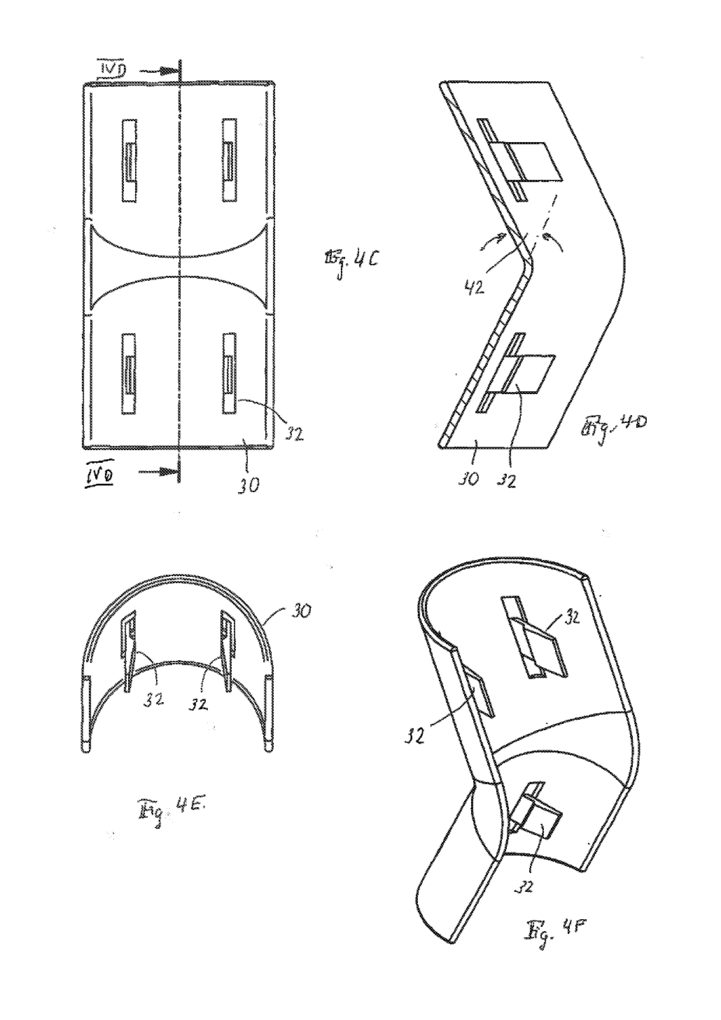

FIG. 1A shows a cable holding device 10 configured according to the invention for fastening cables 12 or cable bundles in thin-walled cabinets, such as sheet metal cabinets, provided with a perforation pattern 16, having a base region 18 which allows fastening in an opening 16 in the thin wall 14 and from which holding strips 20, 22 emerge. As can be seen from FIG. 3C, these holding strips 20, 22 can be connected to one another at the free ends 24, 26 thereof so as to encircle a cable bundle cross section 12. The one holding strip 22 is configured such that it forms or has at its free end a laterally directed pin 34, while the other holding strip 20 forms a bore hole 36 for receiving the pin 34, the pin 34 being insertable therein, possibly under spring tension. The spring tension can be generated by a leaf-spring-like structure of the holding strip which are pre-loaded such that they spring away in direction of the pin axis over the position indicated in FIG. 3A in the neutral position. Pin 34 and bore hole 36 can have knurled or roughened surfaces to facilitate locking of the pin in the bore hole.

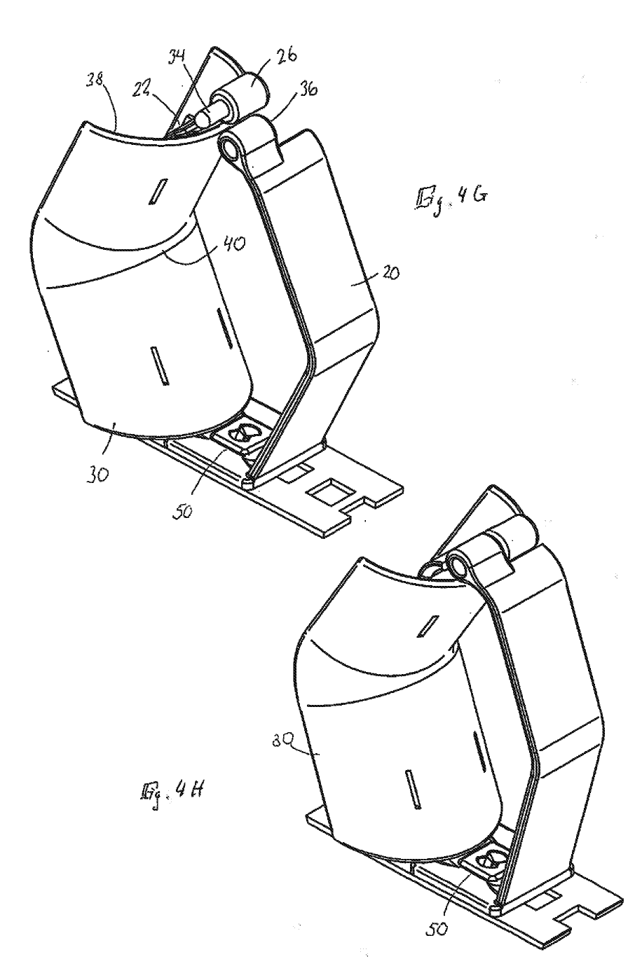

The holding strips 20, 22 are advisably produced from plastic and as a natural outcome of manufacture often have sharp edges 24 which can lead to damage to cables 28 under unfavorable circumstances. To protect cable 12 from damage and kinking, a cable protector 30 is provided according to the invention which can be snapped onto the holding strip 20 or 22 (see FIG. 4G). As can be seen from FIGS. 4C, 4D, 4E, and 4F, holding tabs 32 emerge from the inner surface of the cable protector 30 of the profile and carry the semicircular profile when assembled as is shown by FIG. 4G.

FIG. 3C further shows that the holding strips form a parallelogram after connection of the free ends 24, 26.

With respect to holding strips 20, 22, the connection is carried out in the embodiment form shown in FIG. 1A by means of a pin 34 which emerges from the middle of the one holding strip 22 and fits into a suitable bore hole 36 located in profile direction in the other holding strip 22, 20.

FIGS. 4G and 4H clearly show that the fit to the holding strips the semicircular profile 38 of the cable protector 30 is bent outward in the middle of the longitudinal extension (reference numeral 40).

The bending angle 42—see FIG. 4D—is approximately 30 degrees.

The base region 14, 18 has a square base plate 44 with side length 3S with a square opening 46 with side length 1S, where S is a hole pitch of the perforation of the cabinet.

In the embodiment form shown in FIG. 4A, the base region 14 has a spacer 48 on one side in running direction of the cable. A holding element 50 serves to hold the cable retainer 10 on the thin wall. The holding element 50 grasps the openings of the base region and of the cabinet 46 and 146, respectively, in a clip-like manner in the base region 16 at the thin wall 14. Besides the shape, the additional spacer guard that is possibly also provided also serves to prevent rotation.

The holding element 50 (see also FIG. 3A) can be separate. It is snapped in, whereas a screw driver is inserted into an upper aperture and turned in order to undo it.

The cable retainer 10 can be injection molded from plastic. Reinforcing points 52 in the base region may be useful.

### COMMERCIAL APPLICABILITY

The invention is commercially applicable in switch cabinet construction,

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### LIST OF REFERENCE NUMERALS

10 cable holder, cable retaining device
12 cable, cable bundle
14 thin wall, sheet metal cabinet
16 perforation pattern
18 base region
20 holding strip
22 holding strip
24 free end
26 free end
28 sharp edge
30 cable protector
32 holding tab
34 pin
36 bore hole
38 semicircular profile
40 bend
42 bending angle
44, 144 base plate
46, 146 opening
48 spacer
50 holding element
52 reinforcement

1. Cable retainer (10) for fastening cables (12) or cable bundles in thin-walled cabinets (14), such as sheet metal cabinets, provided with a diameter or perforation pattern (16), having a base region (18) which allows fastening in an opening (16) in the thin wall (14) and from which holding strips (20, 22) emerge, which holding strips (20, 22) can be connected to another (34, 36) at the free ends (24, 26) thereof so as to encircle a cable bundle cross section (12), characterized in that the connection is carried out by means of a pin (34) which emerges from the middle of the one holding strip (22) and fits into a suitable bore hole (36) located in direction of the cable in the other holding strip (34).

2. Cable retainer according to claim 1, characterized in that a spring tension is generated by a leaf spring-like structure of the holding strip (20) between pin (34) and bore hole (36).

3. Cable retainer according to claim 1, characterized in that pin (34) and bore hole (36) have knurled or roughened surfaces to achieve a locking of the pin (34) in the bore hole (36).

4. Cable retainer according to claim 1 or 2 or 3, characterized in that a cable protector (20) can be attached to the holding strips (20, 22).

5. Cable retainer according to claim 1, 2, 3 or 4, characterized in that the cable protector (30) has a semicircular profile (38) having a radius D which is appreciably greater than the width B of the holding strips (20, 22), and in that these holding strips (20, 22) are located between the edges of the semicircular profile (38) and the cable bundle (12).

6. Cable retainer according to claim 5, characterized in that holding tabs (32) which enclose the holding strips (20, 22) under pressure emerge from the inner surface of the semicircular profile (38).

7. Cable retainer according to one of claims 1 to 6, characterized in that the holding lugs (32) form a parallelogram after connection of the free ends (24, 26) of the holding strips (20, 22).

8. Cable retainer according to one of claims 4 to 7, characterized in that the semicircular profile (38) is bent outward in the middle of the longitudinal extension.

9. Cable retainer according to claim 8, characterized in that the bending angle (42) is approximately 30 degrees.

10. Cable retainer according to claim 1, characterized in that the base region (18) comprises a square base plate (44, 144) with side length 3S with a square opening (16) with side length 1S, where S is a hole pitch of the perforation of the cabinet.

11. Cable retainer according to claim 1, characterized in that the base region (18) has on one side in running direction of the cable (12) a spacer (48) which projects into a pitch opening (46) by a distance S.

12. Cable retainer according to claim 1, characterized in that the openings (46) are penetrated by a square clip-like holding element (50).
